(19) United States
(12) Patent Application Publication
(10) Pub. No.: US 2013/0067105 A1
(43) Pub. Date: Mar. 14, 2013

(54) SIP INTERFACE FOR MEDIA RECORDING VIA INAP

(71) Applicants: Jayakumar Balaji, Pallavaram (IN); Balasubramanian Gopalasubramanian, Nanganallur (IN); Nainar Mahalakshmi, Chennai (IN)

(72) Inventors: Jayakumar Balaji, Pallavaram (IN); Balasubramanian Gopalasubramanian, Nanganallur (IN); Nainar Mahalakshmi, Chennai (IN)

(73) Assignee: ALCATEL LUCENT, Paris (FR)

(21) Appl. No.: 13/518,181

(22) PCT Filed: Jan. 18, 2010
(86) PCT No.: PCT/IB10/00604

§ 371 Date: Nov. 20, 2012

(51) Int. Cl. G06F 15/16

(52) U.S. Cl. 709/230

(57) ABSTRACT

A SIP interface for media recording via INAP is disclosed. The present invention relates to SIP networks and, more particularly, to recording messages in SIP networks. Existing recording mechanisms offer only audio and fax based recording services to user for making announcements. Also, existing mechanisms would require a unique announcement ID for every type of media format recorded in the announcement. Thus, the options offered for the users are limited and poses difficulty to the user to enter different announcement ID's for every format. The present invention provides mechanisms wherein users can record announcements using different media types. Media types supported by a media server such as audio, text, video or combination of them may be employed in the recording. In addition, the mechanism provides a single announcement ID which can be employed for recording different media types. Thus, user is provided with options for recording service.

### TECHNICAL FIELD

The present invention relates to SIP networks and, more particularly, to recording messages for announcements in SIP networks.

### BACKGROUND

Intelligent networks (IN) provide several value added services to customers. Services such as audio mails, call forwarding, audio recording for customer announcement and the like are triggered by the IN. The IN triggers such services using Intelligent Network's Application Protocol (INAP) operation such as PROMPT and RECEIVE message (PRM). The INAP services facilitate recording of messages but the recording media type can be only audio or fax signals.

A combination of different types of media recording for customer announcement is not possible; for example, video and text based media recording. In PRM, it is possible to record only audio message and fax signals from the INAP. Further, there is no indication from the INAP for recording other media types such as video or combination of audio, video and text.

In addition, such systems require a separate announcement ID for each media type. For example, in order to play text messages, the announcement ID required would be different from the announcement ID required to play audio messages. As a result, the process is not user friendly as the user will have to enter different sets of codes (or keys) on his cell phone to access the required service. Also, some services require the user to enter the service code along with announcement ID for the required service. In such cases, the user will have to remember the announcement ID for each media type that he would like to access.

### SUMMARY

In view of the foregoing, an embodiment herein provides a system for recording announcements in a Session Initiation Protocol (SIP) network, the system comprising of an intelligent network (IN) for triggering Intelligent Network Application Protocol's (INAP's) Prompt and Receive (PRM) operation in recording announcements; further the IN configured for sending a PRM message; which includes a includes a prompt announcement, a recording ID and indication of media type and further includes a single unique announcement ID for the media types; with a menu for recording, indicating available media types (voice, text, video or a combination of the same); storing user selected media type for recording; storing recorded status of the announcement; and storing the recorded announcement received from the user; at least one Media gateway Controller (MGC) configured for obtaining a Universal Resource Locator (URL) depending on the media type chosen by the user; receiving the recorded announcements, which is linked with the supplementary services of the user, from the user and further sending the announcements to the IN; and at least one media server for facilitating recording of different media types in the announcements using PRM operation.

Embodiments further disclose a Service Control Point (SCP) in an Session Initiation Protocol (SIP) network, the SCP configured with at least one means for sending a Prompt and Receive Message (PRM), which includes a prompt announcement, a recording ID and a media type, with a menu for different media recording to the user; storing the media type selected by the user; storing status of the recorded announcement; and storing the recorded announcement before sending the recorded announcement to preferred destination.

Embodiments herein also disclose a method for recording announcements in a Session Initiation Protocol (SIP) network, the method comprising steps of a user sending a service code for requesting activation of the recording announcement service; a Service Control Point (SCP) sending a Prompt and Collect User Info (PACUI) message to the user with a menu for selecting recording. The PRM Message includes a prompt announcement, a recording ID and media type and which further includes a single unique announcement ID for the media types (voice, text, video or a combination of the same), to the user with a menu for recording; at least one Media Gateway Controller (MGC) selecting a Universal Resource Locator (URL) for the media type selected by the user for recording; a Media Server (MS) sending recording status to the MGC; and the SCP storing the recorded status of the announcement via PRM Result from MGC(SSP) on completion of recording. Additional media types are added in PRM operation depending on media server's Multipurpose Internet Mail Extension (MIME) types. The method is applicable to Customized Applications for Mobile networks Enhanced Logic (CAMEL). The media types are recorded via INAP or CAMEL. The combinations of media types can be recorded in sequential or parallel fashion.

These and other aspects of the embodiments herein will be better appreciated and understood when considered in conjunction with the following description and the accompanying drawings.

### BRIEF DESCRIPTION OF THE FIGURES

The embodiments herein will be better understood from the following detailed description with reference to the drawings, in which:

FIG. 1 illustrates network components of an Intelligent Networks Application Protocol (INAP) for media recording, according to embodiments as disclosed herein;

FIG. 2 is a flow chart depicting the process of media recording, according to embodiments as disclosed herein;

FIGS. 3a and 3b are sequence diagrams illustrating the process of recording a audio message, according to embodiments as disclosed herein;

FIGS. 4a and 4b are sequence diagrams illustrating the process of recording a text message, according to embodiments as disclosed herein; and

FIGS. 5a and 5b are sequence diagrams illustrating the process of recording a video message, according to embodiments as disclosed herein.

### DETAILED DESCRIPTION OF EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

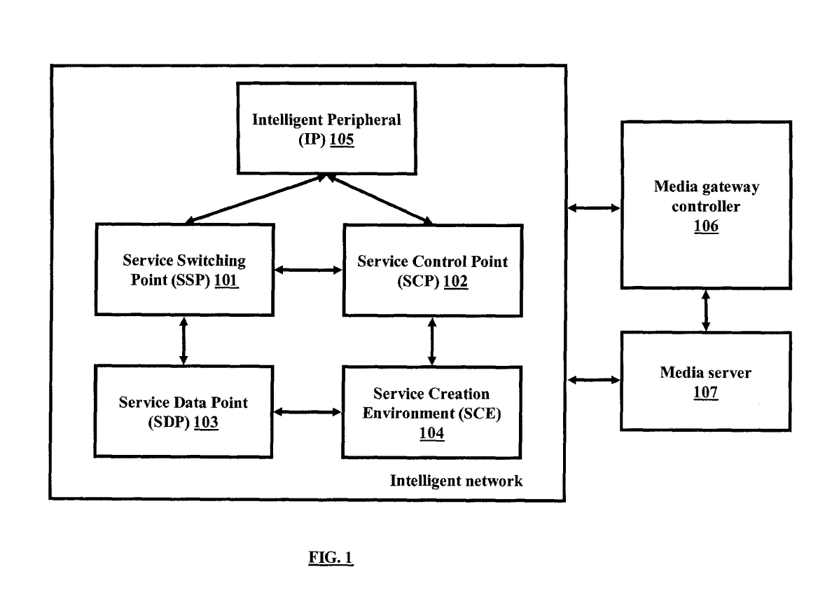

The embodiments herein disclose a mechanism for recording media content in announcement services by providing systems and method thereof. Referring now to the drawings, and more particularly to FIGS. 1 through 5, where similar reference characters denote corresponding features consistently throughout the figures, there are shown embodiments.

A system and method for media based announcement recording services is disclosed. Embodiments herein are described with respect to SIP networks, however can be extended to other networks. The method employs INAP's Prompt and Receive (PRM) message operation in recording announcements. Also, recording can be implemented via Customized Applications for Mobile networks Enhanced Logic (CAMEL). The recording is triggered by the IN. The method enables users to make announcements by choosing different media types for recording. The recording media types can be audio, text and video formats and even combination of the media types. A user who is interested in the recording service may activate his service. On activation, the user is provided with a service code for the media recording service. Service code is a code assigned for a particular service and can be in the form of *123#, *555* and the like. An announcement ID is reserved for the media recording service. The announcement ID is further configured with codes for recording different media types i.e., say sub code 1 for audio, 2 for text and 3 for video and so on.

The user who wants to use media recording service sends the service code assigned for the service to the Media Gateway Controller (MGC). On receiving the service code, the SCP sends Prompt and Collect User Information (PACUI) to collect media type. The prompt announcement in PACUI may be a media selection menu containing details such as dial 1 for audio, dial 2 for text and dial 3 for video. The user then enters his choice for recording, say 3 for video. The user's choice of media is sent as PACUI_Result to the SCP. The SCP then sends PRM based on the media type selected by the user (video in the case). The prompt announcement in PRM may be of the form ‘start your recording’ and announcement ID may be of the form as 500, 111, 123 and the like. The PRM message is sent to the user. Once the PRM is established the user cannot select any further media type. Hence, the selection of the media type is done before PRM is sent via PACUI. The MGC then selects the Universal Resource Locator (URL) based on the user's choice of media. Further, the user's message is recorded. On completion of the recording, the SSP sends a message to the SCP informing the SCP of the end of the recording. Further, the user's recorded message is sent to the destination address.

FIG. 1 illustrates network components of an Intelligent Networks Application Protocol (INAP) for media recording, according to embodiments as disclosed herein. The Intelligent network comprises a Service Switching Point (SSP) 101, a Service Control Point (SCP) 102, a Service Data Point (SDP) 103, a Service Creation Environment (SCE) 104 and an Intelligent Peripheral (IP) 105. In addition, a Media Gateway Controller (MGC) 106 and a Media Server (MS) 107 are interfaced with the IN. The SSP 101 is co-located with the telephone exchange terminal and the SSP 101 acts as a trigger point for services to be invoked during a call. The SSP 101 is responsible for managing calls requiring value added services. The SSP 101 can be a combination of an audio switch and a SS7 switch. The SSP 101 must convert signaling from the audio switch into SS7 signaling messages, which can then be sent to other exchanges through the SS7 network. The SSP 101 receives control and PRM announcement messages from the SCP 102. The SSP 101 processes the PRM messages and sends PRM result messages to SCP 102.

The SCP 102 acts as a set of platforms that receive queries from the SSP 101. The SCP 102 contains service logic, which implements the behavior desired by the operator, i.e., the media recording services. During recording service logic processing, the SCP 102 may obtain additional data required to process the recording service from the SDP 103. The logic on the SCP 102 is created using the SCE 104. The SCP 102 sends control and PRM messages to the SSP 101. Further, on completion of recording, the recorded messages are sent to the SCP 102.

The SDP 103 is a repository that contains data regarding registration, or other data required to process a call or session and the like. For example, media recording service subscription details may be an item stored in the SDP 103 to be queried in real time during the call. The SDP 103 may be a separate module or is sometimes co-located with the SCP 102.

The SCE 104 is the development environment used to create the services present on the SCP 102 such as media recording service. The SCE 104 acts as a platform for implementation of different value added services for customers. The SCE 104 allows user to use graphical interface to manipulate between different functions to formulate a required service.

The IP 105 is a node which can connect to both the SSP 101 and the SCP 102 and delivers additional special resources into the call, mostly related to audio type media data, for example, playing audio announcements or collecting Dual Tone Multiple Frequency (DTMF) tones from the user. When the announcement is in the form of audio or video, IP 105 performs the function of handling the recording of announcements.

The MGC 106 is interfaced with the media server 107 and the intelligent network. The MGC 106 performs the function of processing media recorded messages. MGC 106 acts as a gateway for the messages. MGC 106 also selects a suitable URL for recording based on the type of media selected by the user. For example, if the type of media selected is text then URL selected is TATURL, if the media type is audio, the URL is ANNURL, and if the media type is video the URL is VIDEOURL and so on. The details regarding the status of recorded messages are sent to the MGC. The MGC 106 handles the functioning of the media gateways under its control.

The Media server (MS) 107 is interfaced with the N. The MS 107 stores different types of media such as audio, text and video. Further, addition of different enumerated values for media recording is made possible by the Multipurpose Internet Mail Extension (MIME) types on the MS 107. Recorded messages are sent from the SCP 102 through the MGC 106 to the MS 107 where the message type is stored before transferring the message to the addressed destination.

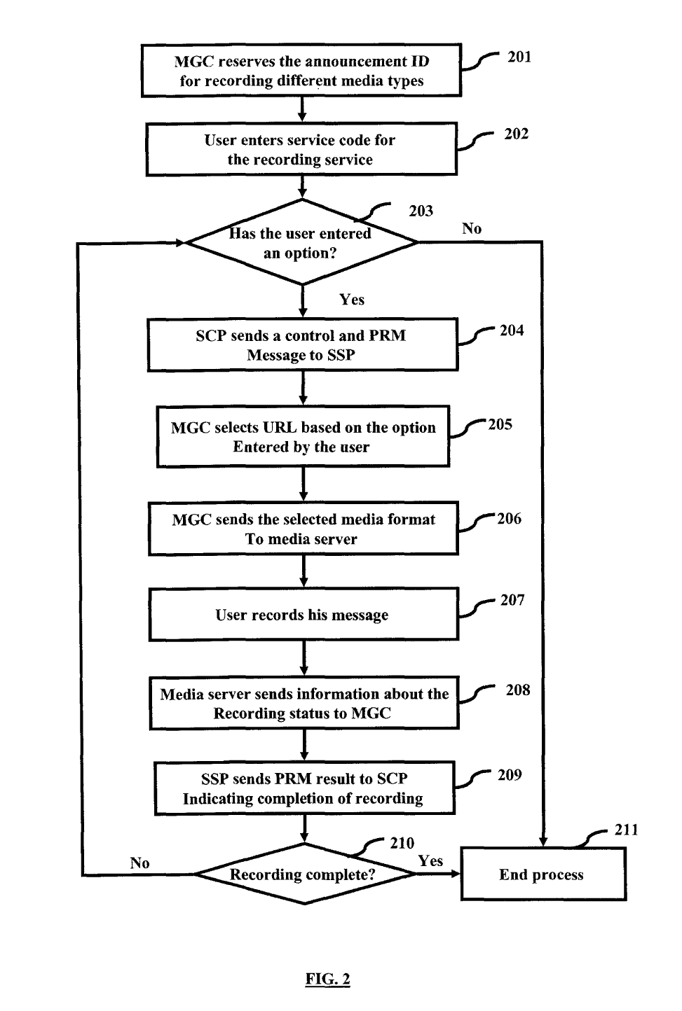

FIG. 2 is a flow chart depicting the process of media recording, according to embodiments as disclosed herein. In the present scenario, different types of media that can be employed for recording announcement messages comprise of audio, text, video or combinations of the same. On activation of the media recording service, the user is provided with a service code. The service code is a unique code allotted by the network service provider for a particular service. The service code can be of the form *123*, *555# and so on. The MGC 106 reserves (201) announcement ID for the media recording service. In an example, say 800 is the announcement ID for the media recording service, which is stored in the MGC 106. When the user wants to access the media recording service, user enters (202) the service code and the service code is sent to the MGC 106, which sends the service code to the SSP 101. On receiving the service code, the recording service is activated for that particular user. A check is made (203) if the user has entered an option. If the user has entered an option, the SCP 102 then sends (204) the control message to the SSP 101. The SCP 102 also sends the PRM message that may contain a prompt announcement along with announcement option, recording ID, and the choice for media type preferred. The prompt announcement may be of the form as ‘start your audio recording’ for audio recording, or ‘start your text recording’ for text recording and the like. The menu for prompt announcement may be of the form: for audio recording press 1; For text recording press 2; For video recording press 3; For audio and text recording press 4; For audio, text and video recording press 5. The user then enters the option preferred by him. Further, the MGC 106 selects (205) the URL based on the type of media selected by the user for recording. In an example, if the type of media selected is text then URL selected is TATURL, if it is audio the URL is ANNURL and so on. On the other hand, if the user has not entered any option the process is ended. The MGC 106 sends (206) details of the selected media format information to the MS 107. The information sent may be of the form <Send INFO: Play, Record audio url=file: /audio.wav, maxtime=15>. The user then records (207) his message. The user may be provided a time duration in which he has to record the message. The MS 107 then sends (208) information about the status of the recorded message to the MGC 106. The SSP 101 then sends (209) the PRM result to the SCP 102 indicating completion of recording. Further, a check is made (210) if the recording is completed for all the chosen media types. If the recording is completed for all the chosen media types, the process is stopped. After completion of recording, the new recording can be started by sending PRM from the SCP 102. In case if the recording is not yet complete, the sequence of steps from 203 to 210 is repeated. The various actions in method 200 may be performed in the order presented, in a different order or simultaneously. Further, in some embodiments, some actions listed in FIG. 2 may be omitted.

In an embodiment, the service logic may provide different types of recording combinations. For example, user dials 800 for recording. The prompt announcement (CTR+PACUI), may indicate the menu as follows: for audio recording press 1; For text recording press 2; For video recording press 3; For audio and text recording press 4; For audio, text and video recording press 5. Further, Depending on selection of the user, SCP 102 sends PRM message as follows: CTR+PRM (audio)+PRM_RLT+PRM (Text)+PRM_RLT (for a case, if user 1 dials digit 4) CTR+PRM (audio)+PRM_RLT+PRM (Text)+PRM_RLT+PRM (Video)+PRM_RLT ((for a case, if user 1 dials digit 5). After the completion of recording for announcement Id 100, this may be linked to Personal Ring Back Tone (PRBT) of the user or any other supplementary services. Supplementary services can include services such as call forwarding (No Reply, Unconditional, Busy), Other user busy services, etc.,

If another user 2 calls user 1 (say a Pizza Shop), then other user 2 will receive announcement Id 100 with all media types, user 2 will hear audio like <<Good Day, Today 50% off for Pizza's>>, user 2 will see the text string as <<50% off, Hurry Up>> and user 2 will see the videos like <<attractive video's of Pizza>>. The display may also be in the form of text scrolling over video image. The PRBT of user 1 may have three types of media. But if an analog user 2 makes a call to user 1, all 3 types of media is transferred from MS 107, then it is up to the calling user's SDP 103 to support or transfer the incoming media RTP packets from the MS 107.

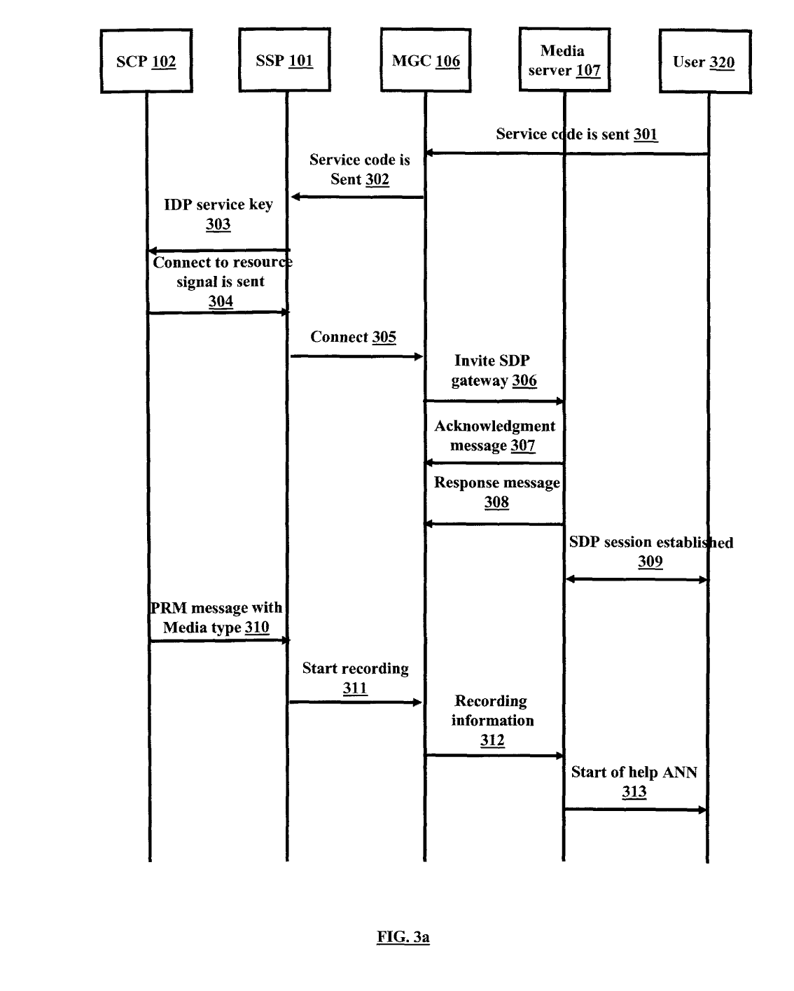

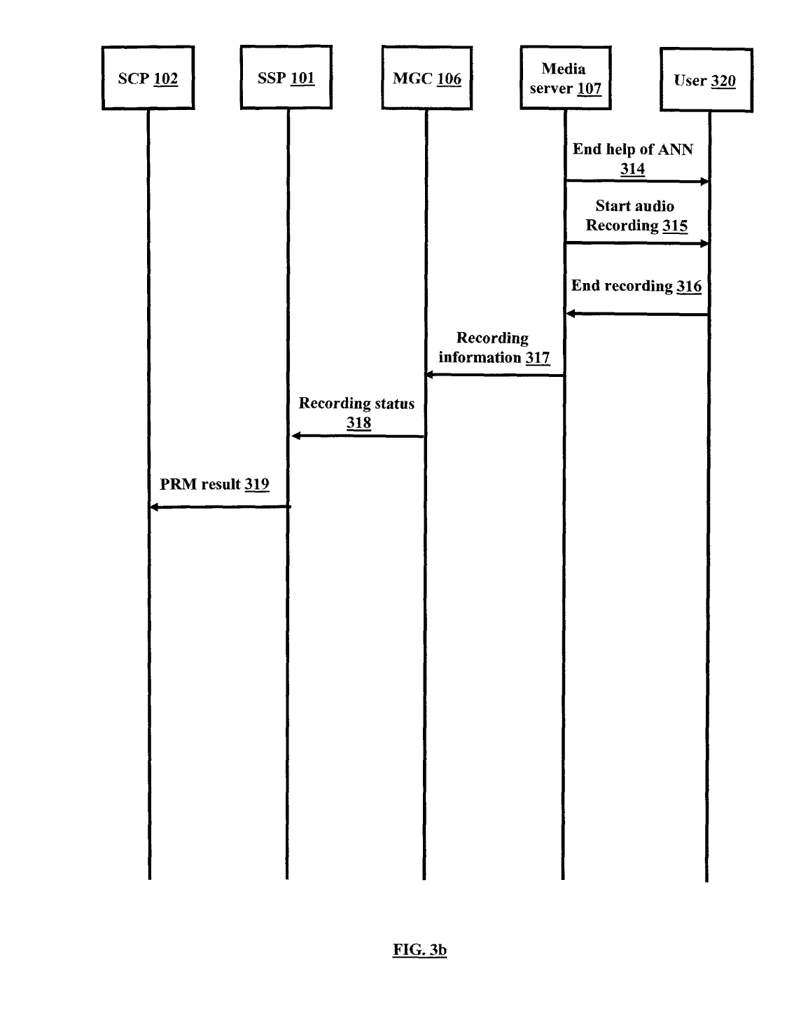

FIGS. 3a and 3b are sequence diagrams illustrating the process of recording an audio message, according to embodiments as disclosed herein. A user 320 who wants to use the media recording service enters the service code allocated by the network operator for media recording service. The service code is sent (301) to the MGC 106 as it acts as a gateway and it scans all the messages to and from the user 320 and the network. The MGC 106 sends (302) the service code to the SSP 101. The SSP 101 decodes the service code to determine the service for which the code is sent. The SSP 101 then sends (303) an IDP service key assigned for media recording service to the SCP 102. The SCP 102 on receiving the IDP service key sends (304) a connect to resource signal to the SSP 101. SCP 101 sends (305) a connect signal to the MGC 106 for connecting the user 320 for media recording service. The MGC 106 on receiving the connect signal sends (306) an invite message to the MS 107. The invite message may be an invite SDP gateway message and the like. The MS 107 then acknowledges the invite message by sending (307) an acknowledgment message. The acknowledgment message may be of the form ‘100 trying’ and the like. The MS 107 also sends (308) a response message in the form of a ‘200 OK’ response message. Further, a two way communication session is established (309) between the user 320 and the MS 107 for communicating messages across the network.

Once the session is established, the SCP 102 sends (310) a PRM message for media recording. The PRM message is sent to the SSP 101. The PRM message may provide details such as a menu with instructions for recording and so on. The PRM message includes a help announcement ID, which may be stated as help Annmid: 1, a record announcement ID, which may be stated as Recannmid: 100, the types of media available for recording and the like. Consider an example where the user 320 chooses audio as the media for recording; this is indicated as audio in the PRM message. The prompt announcement may be of the form ‘start your audio recording’. The format of the PRM message may be: (prompt announcement: 1, record announcement: 100, media type: 0 (audio)). Based on the media type chosen by the user 320, the MGC 106 selects the announcement URL for recording. The SSP 101 sends (311) a message to the MGC 106 to start recording. The MGC 106 sends (312) the media recording information to the MS 107. The information includes <play and record> PLAY AUDIO=file:/ prompt.wav; RECORD AUDIO=file:/audio.way. Recording information may also include details like message ID, message deletion time out, time to record and control digits like end of recording digit, replay digit, cancel digit, restart allowed, replay allowed and so on. The MS 107 sends (313) a start help announcement message to the user 320 in the form of ‘start help ANN’. Further, when the information is obtained by the user, the MS 107 sends (314) end of help message to the user. Depending on the type of media preferred by the user 320 for recording the MS 107 instructs (315) the user 320 to start his recording. When the user 320 has completed his recording, he sends (316) an end of recording message to the MS 107. The MS 107 sends (317) the recorded message to the MGC 106. The information includes <REC LEN, REC STATUS> that indicates the length of the media recorded i.e., audio file length and also the status of the recorded message. Further, the MGC 106 sends (318) the recording status to the SSP 101. The SSP 101 on obtaining the recording status sends (319) the PRM result message to the SCP 102. The media recording is complete and the user 320 can send his recorded message to any destination desired by him.

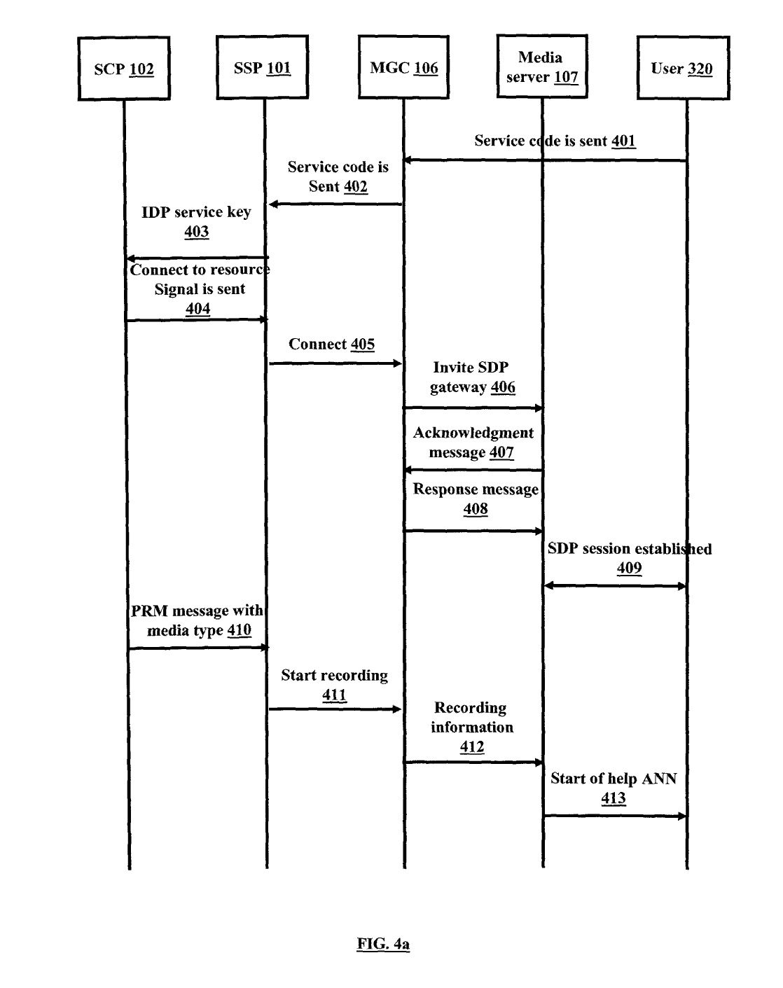

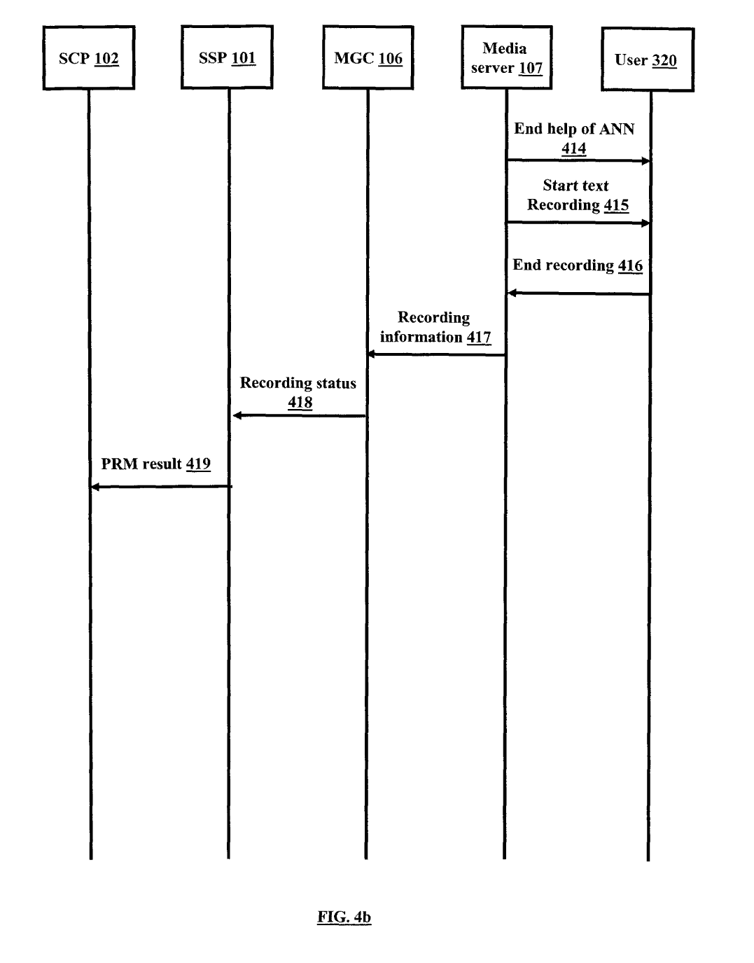

FIGS. 4a and 4b are sequence diagrams illustrating the process of recording a text message, according to embodiments as disclosed herein. A user 320 who wants to use the media recording service sends (401) the service code to the MGC 106. The service code is unique for media recording service and allotted by the network operator. Service code may be like *123#, *555# and so on. The service code is sent (401) to the MGC 106 as it acts as a gateway and scans all the messages to and from the user 320 and the network. The MGC 106 sends (402) the service code to the SSP 101. The SSP 101 decodes the service code to determine the service for which the code is sent. The SSP 101 then sends (403) an IDP service key assigned for media recording service to the SCP 102. The SCP 102 on receiving the IDP service key sends (404) a connect to resource signal to the SSP 101. SCP 101 sends (405) a connect signal to the MGC 106 for connecting the user 320 for media recording service. The MGC 106 on receiving the connect signal sends (406) an invite message to the MS 107. The invite message may be an invite SDP gateway message and the like. The MS 107 then acknowledges the invite message by sending (407) acknowledgment message. The acknowledgment message may be of the form ‘100 trying’ and the like. The MS 107 also sends (408) a response message in the form of a ‘200 OK’ response message. Further, a two way communication session is established (409) between the user 320 and the MS 107 for communicating messages across the network.

After the session is activated, the SCP 102 sends (410) a PRM message to the SSP 101. The PRM message contains the options of media types. The PRM message may provide details such as a menu with instructions for recording and so on. The PRM message includes a help announcement ID, which may be stated as help Annmid: 1, a record announcement ID which may be stated as Recannmid: 100, the types of media available for recording and the like. The prompt announcement may be of the form ‘start your text recording’. In the present case, user 320 chooses text as the media for recording this is indicated in the PRM message. The format of the PRM message may be: (prompt announcement: 1, record announcement: 100, media type: 1 (text)). Based on the media type chosen by the user 320, the MGC 106 selects the announcement URL for recording. The SSP 101 sends (411) a message to the MGC 106 to start recording. The MGC 106 sends (412) the media recording information to the MS 107. The information includes <play and record> PLAY AUDIO=file prompt.wav; RECORD TEXT=file string.dat. Recording information may also include details like message ID, message deletion time out, time to record and control digits like end of recording digit, replay digit, cancel digit, restart allowed, replay allowed and so on. The MS 107 sends (413) a start help announcement message to the user 320 in the form of ‘start help ANN’. Further, when the information is obtained by the user 320, the MS 107 sends (414) end of help message to the user 320. Depending on the type of media preferred by the user 320 for recording, the MS 107 instructs (415) the user 320 to start his recording. When the user 320 is completed with his recording he sends (416) an end of recording message to the MS 107. The MS 107 sends (417) recorded information to the MGC 106. The information includes <REC LEN, REC STATUS> that indicates the length of the media recorded i.e., text file length and also the status. Further, MGC 106 sends (418) the recording status to the SSP 101. The SSP 101 on obtaining the recording status sends (419) the PRM result message to the SCP 102. The media recording is complete and the user 320 can send his recorded message to any destination desired by him.

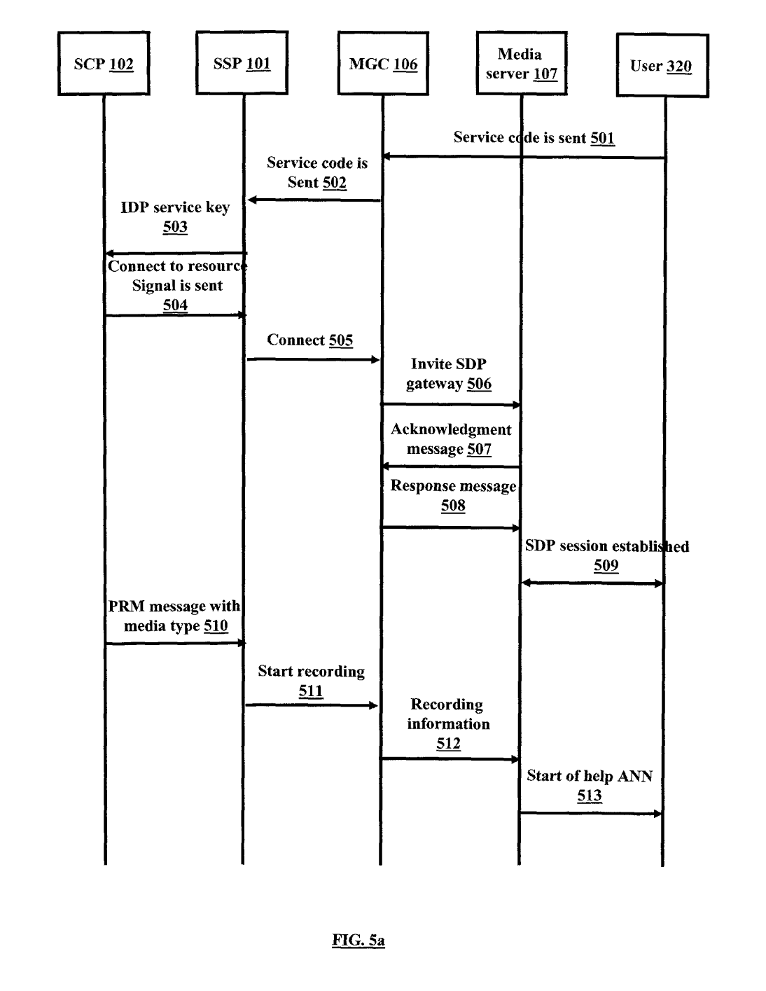

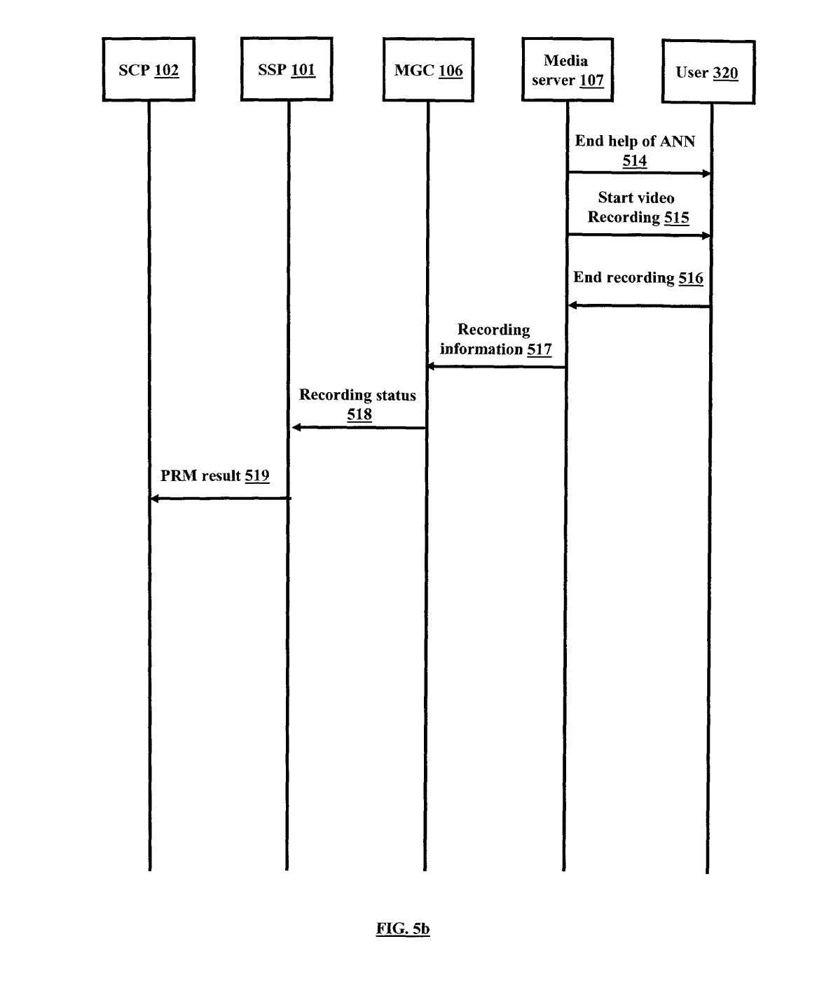

FIGS. 5a and 5b are sequence diagrams illustrating the process of recording a video message, according to embodiments as disclosed herein. user 320 who wants to user media recording service sends the service code allotted for the media recording service to the MS 107. The service code is sent (501) to the MGC 106 as it acts as a gateway and scans all the messages to and from the user and the network. The MGC 106 sends (502) the service code to the SSP 101. The SSP 101 decodes the service code to deter mine the service for which the code is sent. The SSP 101 then sends (503) a IDP service key assigned for media recording service to the SCP 102. The SCP 102 on receiving the IDP service key sends (504) a connect to resource signal to the SSP 101. SCP 101 sends (505) a connect signal to the MGC 106 for connecting the user 320 for media recording service. The MGC 106 on receiving the connect signal sends (506) an invite message to the MS 107. The invite message may be an invite SDP gateway message and the like. The MS 107 then acknowledges the invite message by sending (507) an acknowledgment message. The acknowledgment message may be of the form ‘100 trying’ and the like. The MS 107 also sends (508) a response message in the form of a ‘200 OK’ response message. Further, a two way communication session is established (509) between the user 320 and the MS 107 for communicating messages across the network.

On establishing the session between the user 320 and the SCP 102, the SCP 102 sends (510) PRM message with the media type to the SSP 101. The PRM message indicates the menu with instructions for recording and so on. The PRM message includes a help announcement ID which may be stated as help Annmid: 1, a record announcement ID which may be stated as Recannmid: 100, the types of media available for recording and the like. The prompt announcement may be of the form ‘start your video recording’. In the present case, user 320 chooses video as the media for recording; this is indicated in the PRM message. The format of the PRM message may be: (prompt announcement: 1, record announcement: 100, media type: 2 (video)). Based on the media type chosen by the user 320, the MGC 106 selects the announcement URL for recording. The SSP 101 sends (511) a message to the MGC 106 to start video recording. The MGC 106 sends (512) the media recording information to the MS 107. The information includes <play and record> PLAY AUDIO=file:/ prompt.wav; RECORD VIDEO=file:/ video.3gp. Recording information may also include details like message ID, message deletion time out, time to record and control digits like end of recording digit, replay digit, cancel digit, restart allowed, replay allowed and so on. The MS 107 sends (513) a start help announcement message to the user 320 in the form of ‘start help ANN’. Further, when the information is obtained by the user 320, the MS 107 sends (514) end of help message to the user 320. Depending on the type of media preferred by the user 320 for recording, the MS 107 instructs (515) the user 320 to start his recording. When the user 320 is completed with his recording he sends (516) an end of recording message to the MS 107. The MS 107 sends (517) recorded information to the MGC 106. The information includes <REC LEN, REC STATUS> that indicates the length of the media recorded i.e., video file length and also the status of recording. Further, MGC 106 sends (518) the recording status to the SSP 101. The SSP 101 on obtaining the recording status sends (519) the PRM result message to the SCP 102 indicating media recording is complete and the user 320 can send his recorded message to any destination.

In an embodiment, the implementation of the media recording service employs existing network interfaces. Using INAP and media server 107, recording of different media types is made possible in the same entity. Also, different media types are supported for a single unique announcement ID. Type of media preferred for recording is selected by user via PAUCI in IN recording services. Consider service code assigned for announcement is 800 and announcement ID is 5. After user dials the SAC 800, the SCP 102 sends CTR PACUI for menu selection for selection of media type for recording. In an example, if the analog user selects only audio option PRM gives announcement ID as 5 with the selected media type as audio. If ISDN user selects option text and audio combination for recording, then two cases are possible. In first case, the PRM will send announcement ID as 5 with Media (audio and text), which leads to parallel recording in media server 107. In a second case, the CTR PRM is sent with announcement ID as 5 and type of media selected i.e., audio and text. The message is of the form CTR PRM (Annmid: 5, media (audio))-PRM_RSLT-PRM (Annmid: 5, media (text))-PRM_RSLT, which leads to sequential recording in media server 107.

In addition, the service providers may announce that service code 8001 is always for audio recording, service code 8002 is always for video recording, service code 8003 is always for text recording and service code 8004 is always for audio and text recording combination. In such case, if user dial the service code 8002 the SCP sends CTR PRM with announcement ID as 5 and media selected as video. In this case media selection is dependent on the service code allotted by the service provider.

In an embodiment, it is also possible to increase the offered enumeration values in the media parameter of PRM operations depending on the media server 107 MIME types.

The embodiments disclosed herein can be implemented through at least one software program running on at least one hardware device and performing network management functions to control the network elements. The network elements shown in FIG. 1 include blocks which can be at least one of a hardware device, or a combination of hardware device and software module.

The embodiment disclosed herein specifies a system for recording media for user announcement. The mechanism allows user's to record media announcements by providing a system thereof. Therefore, it is understood that the scope of the protection is extended to such a program and in addition to a computer readable means having a message therein, such computer readable storage means contain program code means for implementation of one or more steps of the method, when the program runs on a server or mobile device or any suitable programmable device. The hardware device can be any kind of device which can be programmed including e.g. any kind of computer like a server or a personal computer, or the like, or any combination thereof, e.g. one processor and two FPGAs. The device may also include means which could be e.g. hardware means like e.g. an ASIC, or a combination of hardware and software means, e.g. an ASIC and an FPGA, or at least one microprocessor and at least one memory with software modules located therein. Alternatively, the invention may be implemented on different hardware devices, e.g. using a plurality of CPUs.

What is claimed is:

1. A system for recording announcements in a Session Initiation Protocol (SIP) network, said system comprising of:
an intelligent network (IN) for triggering Intelligent Network Application Protocol's (INAP's) Prompt and Receive (PRM) operation in recording announcements; further said IN configured for:
sending a PRM message with a menu for recording, indicating available media types;
storing user selected media type for recording;
storing recorded status of said announcement; and
storing said recorded announcement received from said user;
at least one Media gateway Controller (MGC) configured for:
obtaining a Universal Resource Locator (URL) depending on the media type chosen by said user;
receiving said recorded announcements from said user and further sending said announcements to said IN; and
at least one media server for facilitating recording of different media types in said announcements using PRM operation.

2. The system as in claim 1, wherein said system is configured to include a prompt announcement, a recording ID and indication of media type with said PRM message.

3. The system as in claim 1, wherein said system is configured to include a single unique announcement ID for said media types in said PRM message.

4. The system as in claim 1, wherein said system is configured to link said recorded announcement with a supplementary service.

5. A Service Control Point (SCP) in an Session Initiation Protocol (SIP) network, said SCP configured with at least one means for:
sending a Prompt and Receive Message (PRM) with a menu for different media recording to said user;
storing the media type selected by said user;
storing status of said recorded announcement; and
storing said recorded announcement before sending said recorded announcement to preferred destination.

6. The SCP as in claim 6, wherein said SCP is configured to send a prompt announcement, a recording ID and a media type with said PRM message.

7. A method for recording announcements in a Session Initiation Protocol (SIP) network, said method comprising steps of:
a user sending a service code for requesting activation of said recording announcement service;
a Service Control Point (SCP) sending a Prompt and Collect User Info (PACUI) message to said user with a menu for selecting recording;
at least one Media Gateway Controller (MGC) selecting a Universal Resource Locator (URL) for said media type selected by said user for recording;
a Media Server (MS) sending recording status to said MGC; and
said SCP storing said recorded announcement status on completion of recording.

8. The method as in claim 7, wherein said PRM message includes a prompt announcement, a recording ID and media type.

9. The method as in claim 7, wherein said PRM message includes a single unique announcement ID for said media types.

10. The method as in claim 7, wherein said media types are voice, text, video or the combination of at least two of the same.

11. The method as in claim 7, wherein additional media types are added in PRM operation depending on media server's Multipurpose Internet Mail Extension (MIME) types.

12. The method as in claim 7, wherein said method is applicable to Customized Applications for Mobile networks Enhanced Logic (CAMEL).

13. The method as in claim 7, wherein said media types are recorded via INAP or CAMEL.

14. The method as in claim 7, wherein combinations said media types can be recorded in sequential or parallel fashion.
